(19) United States
(12) Patent Application Publication
(10) Pub. No.: US 2016/0172081 A1
(43) Pub. Date: Jun. 16, 2016

(54) Method for Producing High-Voltage Insulation of Electrical Components

(71) Applicant: Tesat-Spacecom GmbH & Co. KG, Backnang (DE)

(72) Inventors: Hanspeter KATZ, Stuttgart (DE); Andreas BLASS, Untergruppenbach (DE)

(21) Appl. No.: 14/967,181

(22) Filed: Dec. 11, 2015

(30) Foreign Application Priority Data
Dec. 12, 2014 (DE) 10 2014 018 277.0

(51) Int. Cl. H01B 13/06; B29C 67/00

(52) U.S. Cl. CPC H01B 13/06; B29C 67/0055; B33Y 10/00

(57) ABSTRACT

A method for producing high-voltage insulation of electrical components includes applying a first layer of insulation material to the electrical component and applying a second layer of insulation material to the electrical component. The second layer is applied, at least in sections, to the first layer so that the first layer is situated, at least in sections, between the second layer and the electrical component. This method makes it possible to electrically insulate electrical parts on the electrical component as needed, and at the same time, to reduce the quantity of insulation material required.

### CROSS REFERENCE TO RELATED APPLICATIONS

This application claims priority under 35 U.S.C. §119 from German Patent Application No. 10 2014 018 277.0, filed Dec. 12, 2014, the entire disclosure of which is herein expressly incorporated by reference.

### FIELD OF THE INVENTION

The invention relates to a method for producing high-voltage insulation, in particular for producing high-voltage insulation for electrical components that are used in a vacuum.

### BACKGROUND OF THE INVENTION

Electrical components which are used in satellites, for example, are provided with electrical insulation for purposes of test procedures on Earth and for transport from Earth into an earth orbit. In particular circuit parts for space equipment operated under high voltage are generally cast all over with an insulation material to make them operationally reliable during operation on Earth, i.e., within the atmosphere prevailing on Earth, and to make them resistant to flashover during operation in a vacuum, i.e., during revolution or orbit around the earth, and during transfer to that location.

In such casting of the electrical components, solid casting of an assembly is customarily carried out. In the process, the assembly is placed in a casting mold, and a typically liquid insulation material is filled into the casting mold and allowed to cure in order to completely cover the assembly with insulation material.

### SUMMARY OF THE INVENTION

The object of the invention may be regarded as simplifying the production of high-voltage insulation, and in particular to reduce the quantity of insulation material required for producing high-voltage insulation of components for use in earth orbit.

This object is achieved by the subject matter having the features of the independent claim. Refinements of the invention result from the dependent claims and from the following description.

According to one aspect of the invention, a method for producing high-voltage insulation of electrical components is provided. The method comprises the following steps: applying a first layer of insulation material to the electrical component and applying a second layer of insulation material to the electrical component, wherein the second layer is applied, at least in sections, to the first layer so that the first layer is situated, at least in sections, between the second layer and the electrical component.

The electrical component may be an electrical assembly having a printed circuit board and/or a plurality of parts. The parts are arranged on the printed circuit board or freely wired. The printed circuit board is typically a flat planar element.

Applying the second layer, at least in sections, to the first layer means that the first layer and the second layer overlap, at least in sections. The first layer and the second layer are applied to a surface of the electrical component, in particular to the printed circuit board and the parts. The second layer is applied over the first layer in a direction perpendicular to the plane of the printed circuit board, and thus overlaps the first layer, at least in sections.

By applying the insulation material in layers, the quantity of insulation material above each individual point on the surface of the printed circuit board or of an electrical part may be specified. A layer of insulation material may extend in particular solely over a portion of a surface of the electrical component, i.e., the printed circuit board or a part, and does not necessarily have to extend over the entire surface. Cast resin or any other insulation material suitable for high voltage, for example Solithane, may be used as insulation material.

This method thus makes it possible to electrically insulate electrical parts on the electrical component as needed, and at the same time, to reduce the quantity of insulation material required. In comparison to solid casting, in which essentially a block of insulation material is provided around the electrical component, regardless of the placement of the parts, the method described herein allows insulation material to be applied as needed, i.e., in particular around and above electrical parts. The layers of the insulation material may extend in any desired shapes along the surface of the electrical component.

The method is characterized in particular in that the components electrically insulated in this way have a much lower weight, thermomechanical stress on the electrical component and the parts used is reduced, casting molds are no longer necessary, and insulation having basically any shape is possible using the method.

The layers of the insulation material may be applied to the electrical component using a so-called 3D printer, for example. In 3D printing, a body having an extension in three spatial directions is produced by building up the body in layers and applying one layer over the other. A three-dimensional body having virtually any shape may be produced by changing the lateral extension of the material of the layers.

The method described herein makes it possible in particular for the second layer to have a lateral offset relative to the first layer, i.e., for the second layer to have a lateral extension which is different from the first layer. The lateral extension corresponds to the flat span of a layer along a surface of the electrical component.

In one embodiment, the method may provide that the electrical component is printed with insulation material using a so-called 3D printer; i.e., the insulation material is applied to a surface of the electrical component, in particular sprayed or spread in general. For this purpose, the electrical component may be situated in a working area of the 3D printer so that the locations to be insulated may be reached by a nozzle of the 3D printer.

According to one embodiment of the invention, the method described herein further comprises the following step: applying an nth layer of insulation material to the electrical component, wherein the nth layer is applied, at least in sections, to the (n−1)th layer.

This means that the method may in principle provide that any desired number of layers may be applied so that they overlap one another, at least in sections. A layer n is applied to the layer n−1 applied immediately before it, and the layers are situated one above the other in a direction perpendicular to a surface of the electrical component.

By means of this step, or this plurality of steps which may be carried out in succession, for applying a plurality of layers of insulation material to the electrical component, it is possible to apply the insulation material to the electrical component in any desired lateral contours (i.e., at which locations along the surface of the electrical component insulation material is applied) in any desired thickness (how many layers are situated one above the other). In setting the number of layers, a stress load in an area of the electrical component may be taken into account, and the number of layers may be correspondingly set.

According to another embodiment of the invention, the step of applying an nth layer of insulation material to the (n−1)th layer of insulation material is repeated until a predetermined insulation material thickness on the electrical component is reached.

The desired insulation material thickness may be between 1/10 millimeter and several millimeters, for example between 6 and 12 mm. The insulation material may be applied, for example, in layers having a thickness of a few tenths of a mm to 1 mm in each case. By means of the method described herein, in particular the height of the insulation material on the electrical component may be adapted to the height contour of the latter in order to apply only the necessary quantity of insulation material at a location on the electrical component. The insulation material thickness may be different on adjacent parts, and may be adapted to the local requirements (i.e., the requirements at a point or a flat section of the surface of the electrical component).

According to another embodiment of the invention, the step of applying the first layer of insulation material to the electrical component comprises the following substep: applying the insulation material in the liquid state to a surface of the electrical component.

In this method step, the insulation material is sprayed or spread onto the surface of the electrical component.

According to another embodiment of the invention, after applying the insulation material of the first layer, the second layer is not applied until the insulation material of the first layer has at least partially cured.

According to another embodiment of the invention, the method further comprises the following steps: applying a first insulation section to the electrical component and applying a second insulation section to the electrical component, wherein the first insulation section is situated at a distance from the second insulation section along a surface of the electrical component.

These method steps allow a reduction in the quantity of the insulation material and a reduction in the weight of the insulated electrical components. The two insulation sections are created in layers, either in succession or concurrently, as described above for the method for producing the high-voltage insulation. The insulation sections may be regarded as separate, spaced-apart, non-overlapping pieces of insulation, each of which is associated with an electrical part. In other words, the insulation sections form so-called insulation material islands on the electrical component.

Due to this design of the high-voltage insulation, the weight may be reduced even further. In particular, in a vacuum this design allows vacuum insulation to be provided between the two insulation sections.

According to another embodiment of the invention, the method further comprises the following step: providing a recess in the electrical component between the first insulation section and the second insulation section.

The recess is, for example, an opening in the form of a slit in the electrical component, for example in a printed circuit board equipped with electrical parts, and the recess extends between the two insulation sections or between the electrical parts situated therebeneath in order to increase the creep resistance.

According to another embodiment of the invention, a plurality of superposed layers of insulation material in the form of a closed traverse made of a first insulation material is applied to the electrical component, so that the closed traverse encloses a portion of a surface of the electrical component and an electrical part situated thereon. The method further comprises the step of: applying a second insulation material to the surface of the electrical component enclosed by the closed traverse.

The first insulation material is applied to a surface of the electrical component as a wall which extends perpendicularly with respect to the electrical component, and extends as a closed traverse; i.e., the wall made of first insulation material completely encloses a portion of the surface of the electrical component, for example a portion of the surface on which an electrical part is situated on the printed circuit board. The second insulation material is applied to the electrical component after the first insulation material is applied to the surface area enclosed by the closed traverse.

These steps allow an extension area of the second insulation material to be limited to the surface of the electrical component, namely, by means of the closed traverse made of first insulation material.

According to another embodiment of the invention, during application to the electrical component, the second insulation material has a lower viscosity than the first insulation material.

In this context, viscosity refers to the viscosity during application of the first insulation material and the second insulation material. The second insulation material may in particular have such a low viscosity that it flows into empty spaces beneath an electrical component and does not remain at the location of the surface of the electrical component to which it has been applied. In other words, after the application, the second insulation material initially flows or spreads over the surface of the electrical component delimited by the closed traverse. The second insulation material as well is designed to cure. The viscosity of the second insulation material may be changed, in particular increased, for example by changing the application temperature of the second insulation material, or by using an insulation material having a lower viscosity.

According to another embodiment of the invention, the method further comprises the step of: applying an electrically conductive layer to the insulation material, so that the insulation material is situated between the electrically conductive layer and the electrical component.

The electrically conductive layer may be used in particular for electromagnetically shielding an electrical part, specifically, for shielding from external influences and shielding adjacent parts from the part provided with the electrically conductive layer. The electrically conductive layer may extend in such a way that it is electrically coupled to a housing of the electrical component.

According to another embodiment of the invention, the method is used for producing high-voltage insulation of electrical components which are provided for use in an airless space in earth orbit.

Such components may be, for example, satellite components, for example travelling wave tubes (TWT) or parts thereof. TWTs are customarily used as power amplifiers in satellites. They are made up of a travelling wave tube which primarily determines the high-frequency properties, and a power supply which generates the supply voltage, generally a high voltage, for the TWT, and which represents the telemetry and telecommand interface with satellites. Rectifier stages connected in series are used for generating the high voltages necessary for operation. For operation in space travel, the rectifier stages must be electrically insulated from one another and from the housing. Such insulation is made possible by the method described herein.

Since a vacuum is present in the earth orbit in which a satellite is generally operated, the insulation is typically required only for the test phase on Earth and for the transport phase, due to the fact that in principle, insulation is present in a vacuum. Dispensing with insulation material thus offers the advantage that the weight of the electrical component is reduced in order to reduce the level of effort for transport into the earth orbit. In addition, in a vacuum the insulating property of the insulation material is not necessary, since insulation is provided by the vacuum. Full enclosure of the electrical component may even result in a decrease in the insulating performance due to aging phenomena of the insulation material, which may be undesirable. A vacuum is present between the insulation sections specifically when multiple insulation sections are provided for individual parts, and the insulation of these two electrical parts from one another cannot be impaired by degraded insulation material.

Any material suitable for high voltage and which provides electrical insulation may be used as insulation material. For example, Solithane may be used as insulation material.

According to another embodiment of the invention, the insulation material is applied to the electrical component by means of a 3D printing process.

The insulation material is applied in layers, and the lateral extension and shape of each layer may be individually set and adapted to the contour of the electrical component in such a way that the quantity of the required insulation material is reduced, and the quality of the insulation is still essentially maintained.

Exemplary embodiments of the invention are described below with reference to the drawings.

### BRIEF DESCRIPTION OF THE DRAWINGS

FIG. 1 shows a schematic illustration of an electrical component.

FIG. 2 shows a side view of an electrical component with applied insulation material, using a method according to one exemplary embodiment of the invention.

FIG. 3 shows a top view of an electrical component with applied insulation material, using a method according to another exemplary embodiment of the invention.

FIG. 4 shows a side view of an electrical component with applied insulation material, using a method according to another exemplary embodiment of the invention.

FIG. 5 shows a top view of the illustration in FIG. 4.

FIG. 6 shows a side view of an electrical component with applied insulation material, using a method according to another exemplary embodiment of the invention.

FIG. 7 shows a side view of an electrical component with applied insulation material and an electrically conductive coating, using a method according to another exemplary embodiment of the invention.

### DETAILED DESCRIPTION OF EXEMPLARY EMBODIMENTS

The illustrations in the figures are schematic and not true to scale. When the same reference numerals are used, these refer to identical or similar elements.

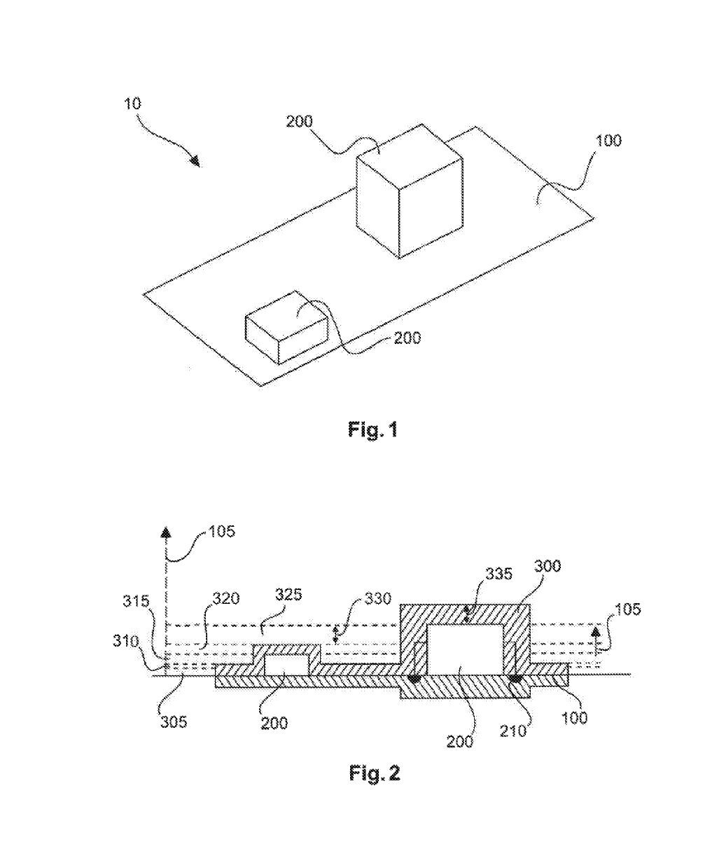

FIG. 1 shows a schematic isometric illustration of an electrical component 10 comprising a support element, for example a printed circuit board 100, and two electrical parts 200 which are situated on a surface of the support element and mechanically and electrically coupled to the support element. The electrical parts 200 may be individual electrical or electronic components such as an inductor, a capacitor, or an integrated circuit, for example. It is pointed out that the method described herein may be carried out with all possible electrical components having any geometric shape.

In a conventional method for casting the electrical component 10, a casting mold is provided which is substantially adapted to the contour of the electrical component 10. The electrical component 10 is then placed in the casting mold, and a liquid insulation material is poured over it. The insulation material cures, and the cast electrical component is subsequently removed from the casting mold. This conventional method involves solid casting which is carried out as complicated close contour casting.

In contrast, the method according to the invention allows very simple production and good thermomechanical adaptation, and at the same time, a minimal quantity of insulation material and very good suitability for high voltage, which to the required long service life of 15 to 20 years, for example, for satellite components. In addition, the method according to the invention allows a casting mold to be dispensed with entirely, so that the complicated production thereof may also be dispensed with.

FIG. 2 shows a side sectional illustration of an electrical component. The electrical parts 200 extend along the arrow 105, perpendicularly with respect to a surface of the printed circuit board 100. Electrical parts 200 may be situated on a top side and also on a bottom side of the printed circuit board 100, and may be electrically and/or mechanically coupled to the printed circuit board 100 via connecting elements 210. Insulation material, the same as for electrical parts, may be applied to the top side and also to the bottom side of the printed circuit board 100 and electrical parts situated there.

The insulation material 300 is applied in layers 305, 310, 315, 320, and 325 situated one on top of the other. The layers of the insulation material are situated on top of one another in the perpendicular direction 105 with respect to the printed circuit board 100. The lateral extensions and shapes of the layers, i.e., the extensions and shapes of the layers in a direction from left to right in FIG. 2, may differ from one another. As a result, the contour of the insulation material 300 may be adapted to the contour of the electrical component. For example, the height of the insulation material 300 between the two electrical parts 200 may be less than the height of the electrical parts in order to reduce the quantity of the insulation material. Due to the layered application of the insulation material to the electrical component and the setting of the lateral extension of each individual layer of the insulation material, insulation material may be applied in the area of the electrical parts in a way that is required for high-voltage insulation while still keeping the quantity of insulation material as small as possible.

The individual layers of the insulation material may be applied, for example, using a spray head which moves in parallel to the surface of the printed circuit board 100. The surface of the printed circuit board 100 may, for example, be traversed line by line, and the insulation material may be applied in these lines, whereby the length and individual segments of each line may be set. A line is a strip of insulation material, which in the illustration in FIG. 2 is applied from left to right and which may be continuous or interrupted; i.e., a line may be made up of multiple segments. A line may have a specified width, for example a few tenths of a millimeter to several millimeters. The width of a line corresponds to its extension in a direction in the plane of the drawing or out of the plane of the drawing in FIG. 2.

A layer of the insulation material may have a thickness 330 of a few tenths of a millimeter, for example. The thickness of the insulation material on an electrical part, i.e., the height 335 of the insulation material, may be between 1/10 millimeter and several millimeters, for example 6 to 12 millimeters. In addition, the lateral overhang of the insulation material relative to an electrical part may correspond approximately to this value; i.e., the insulation material may have a side or lateral overhang, relative to an electrical part, between 1/10 millimeter and several millimeters, for example 6 to 12 millimeters.

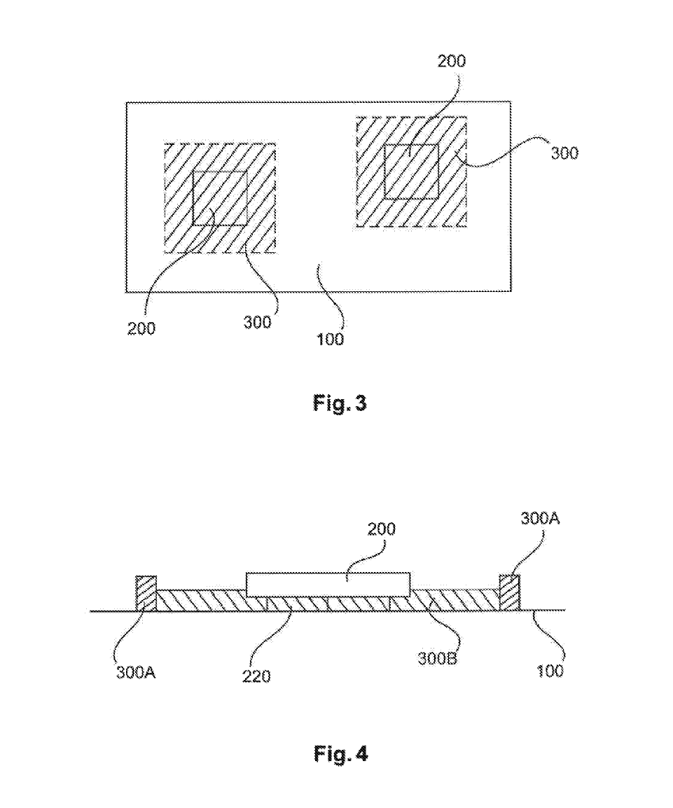

FIG. 3 shows a top view of an electrical component, wherein in each case two insulation material sections 300 are applied, one each over a respective electrical component 200. The two insulation material sections 300 may be applied at the same time by applying in each case the layer n of the first insulation material section and of the second insulation material section in one step, and subsequently applying the layer n+1 of the first insulation material section and of the second insulation material section in the next step. As the result of being able to specify the lateral extension and shape of each individual layer of the insulation material, separate insulation material sections which are spaced apart from one another may be applied to the electrical component using the method according to the invention.

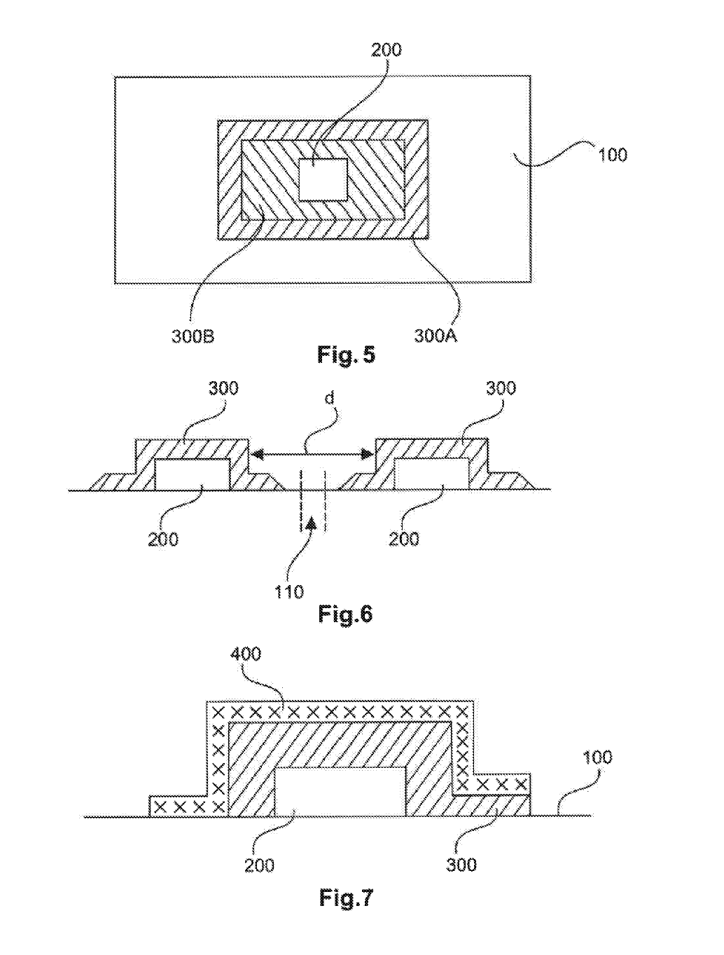

FIG. 4 shows a side view of a sectional illustration of an electrical component. FIG. 5 shows a top view of the illustration in FIG. 4, and reference is made to both figures in the following description.

A closed traverse made of first insulation material 300A having a desired height is applied to the printed circuit board 100 in a first step. As is apparent in FIG. 5, the closed traverse represents a rectangle which encloses the electrical component 200. The first insulation material 300A may represent a closed traverse of any desired shape, for example a circle or some other shape, which meets the function of enclosing the electrical component, in particular, preferably in such a way that the closed traverse has a distance>0 mm from the electrical part 200.

In a subsequent step, a second insulation material 300B is applied to the section of the surface of the printed circuit board 100 enclosed by the closed traverse 300A. The second insulation material 300B may in particular have a characteristic or viscosity such that after the application, the second insulation material may flow over the printed circuit board and penetrate, for example, into a gap between the electrical part 200 and the printed circuit board 100. The gap may in particular be a mounting distance 220.

Due to the application of the second insulation material having a high viscosity, during the application in particular the creation of air inclusions in the high-voltage insulation may be prevented, since the second insulation material flows into the gap 220 and displaces the air. The first and second insulation materials may be thixotropic material, for example, since both are applied in the liquid state and cure after a determinable period.

The first insulation material 300A and the second insulation material 300B may be applied in alternation. Thus, for example, after the second insulation material 300B is applied, the closed traverse may be increased by reapplying first insulation material to the existing traverse. An additional quantity of the second insulation material 300B may be subsequently applied.

FIG. 6 shows a printed circuit board 100 having two electrical parts 200. Both parts 200 are enveloped in insulation material 300, so that two insulation material sections are formed here. A distance d is present between the two insulation material sections. In orbit, i.e., when the electrical component is used in a vacuum, a vacuum is present between the insulation material sections, thus making it possible to improve the high-voltage insulation.

A recess 110 may be situated in the printed circuit board 100, between the insulation material sections. The recess 110 may in particular be a slit over the entire material thickness of the printed circuit board 100 (indicated here with the two dashed lines, whose spacing corresponds to the width of the slit), in order to improve the creep resistance of the electrical component.

FIG. 7 shows an illustration of an electrical component, wherein an electrically conductive layer 400 is situated above the insulation material 300. The electrically conductive layer 400 may electromagnetically shield the electrical part 200, and thus improve the electromagnetic compatibility of the electrical component. The electrically conductive layer 400 may be electrically coupled to the printed circuit board.

### LIST OF REFERENCE NUMERALS

10 Electrical component
100 Support element, printed circuit board
105 Perpendicular to a support element plane
110 Recess
200 Electrical part
210 Connecting element
220 Mounting distance
300 Insulation material
300A Closed traverse made of first insulation material
300B Second insulation material
305 First layer
310 Second layer
315 Third layer
320 Fourth layer
325 Fifth layer
330 Layer thickness
335 Minimum insulation layer thickness
400 Electrically conductive layer

What is claimed is:

1. A method for producing high-voltage insulation of electrical components, comprising the acts of:
applying a first layer of insulation material to the electrical component; and
applying a second layer of insulation material to the electrical component;
wherein the second layer is applied, at least in sections, to the first layer so that the first layer is situated, at least in sections, between the second layer and the electrical component.

2. The method according to claim 1, further comprising:
applying an nth layer of insulation material to the electrical component,
wherein the nth layer is applied, at least in sections, to the (n−1)th layer.

3. The method according to claim 2,
wherein applying the nth layer of insulation material to the (n−1)th layer of insulation material is repeated until a predetermined insulation material thickness on the electrical component is reached.

4. The method according to claim 1,
wherein applying the first layer of insulation material to the electrical component further comprises applying the insulation material in a liquid state to a surface of the electrical component.

5. The method according to claim 2,
wherein applying the first layer of insulation material to the electrical component further comprises applying the insulation material in a liquid state to a surface of the electrical component.

6. The method according to claim 3,
wherein applying the first layer of insulation material to the electrical component further comprises applying the insulation material in a liquid state to a surface of the electrical component.

7. The method according to claim 4,
wherein after said applying the insulation material of the first layer, the second layer is not applied until the insulation material of the first layer has at least partially cured.

8. The method according to claim 5,
wherein after said applying the insulation material of the first layer, the second layer is not applied until the insulation material of the first layer has at least partially cured.

9. The method according to claim 6,
wherein after said applying the insulation material of the first layer, the second layer is not applied until the insulation material of the first layer has at least partially cured.

10. The method according to 1, further comprising:
applying a first insulation section to the electrical component; and
applying a second insulation section to the electrical component,
wherein the first insulation section is situated at a distance from the second insulation section along a surface of the electrical component.

11. The method according to claim 10, further comprising providing a recess in the electrical component between the first insulation section and the second insulation section.

12. The method according to claim 1,
wherein a plurality of superposed layers of insulation material in the form of a closed traverse made of a first insulation material is applied to the electrical component, so that the closed traverse encloses a portion of a surface of the electrical component and an electrical part situated thereon, wherein the method further comprises:
applying a second insulation material to the surface of the electrical component enclosed by the closed traverse.

13. The method according to claim 12, wherein during application to the electrical component, the second insulation material has a lower viscosity than the first insulation material.

14. The method according to claim 1, further comprising:
applying an electrically conductive layer to the insulation material, so that the insulation material is situated between the electrically conductive layer and the electrical component.

15. The method according to claim 1, further comprising:
producing, according to the method of claim 1, high-voltage insulation of electrical components adapted for airless space in earth orbit.

16. The method according to claim 1,
wherein the insulation material is applied to the electrical component by means of a 3D printing process.
